(19) United States
(12) Patent Application Publication
(10) Pub. No.: US 2018/0180456 A1
(43) Pub. Date: Jun. 28, 2018

(54) PULSE CANCELLING FOR FLOW MEASUREMENTS

(71) Applicant: PROVTAGAREN AB, Hässleholm (SE)

(72) Inventors: Daniel Ottosen, Lund (SE); Gunnar Skarping, Hässleholm (SE); Marianne Dalene, Hässleholm (SE)

(21) Appl. No.: 15/735,393

(22) PCT Filed: Jun. 13, 2016
(86) PCT No.: PCT/SE2016/050566

§ 371 Date: Dec. 11, 2017

(30) Foreign Application Priority Data
Jun. 12, 2015 (SE) 1550801-3

(51) Int. Cl. G01F 1/684; F16L 55/033; F16L 55/04; G05D 16/20

(52) U.S. Cl. CPC G01F 1/6842; F16L 55/0333; G01N 1/14; G05D 16/2066; F16L 55/041

(57) ABSTRACT

Apparatus and a method for sampling fluid flow quality. The apparatus includes a flow channel through which the fluid is flowing, a pressure sensor provided in said flow channel and adapted to detect a pressure in said flow channel, a membrane provided downstream or upstream said pressure sensor in said flow channel and adapted to induce a pressure modification, and a control unit connected to said pressure sensor and said membrane. The control unit is configured to activate said membrane so as to induce said pressure modification when said detected pressure deviates from a predetermined pressure interval, thereby neutralizing any pressure fluctuation in said flow channel.

### TECHNICAL FIELD

The present invention relates generally to a method for controlling and/or measuring a fluid flow of a fluid detecting device for detecting the presence of a substance in a fluid in an area. More particularly, the present invention relates to a fluid detecting and/or monitoring device as defined in the introductory parts of claim 1 and to a method device for detecting the presence of a substance in a fluid in an area as defined as defined in the introductory parts of claim 13.

### BACKGROUND Art

In fluid sampling scenarios for different pollutants and different analysis methods, fluid, either gas or liquid, is usually drawn through a sampling device where fluid pollutants are trapped and thereby detected and/or sampled. Most sampling devices are connected to a pump that will draw the fluid through the sampling equipment. To be able to quantify the results, it is important to have a known fluid flow through the sampling equipment to be able to get a correct value for the total volume that is sampled so that a correct concentration of any pollutants may be calculated.

The pump used to create the flow through the sampling equipment is, however, not able to create a laminar flow through the sample. All kinds of pumps have imperfections creating an uneven fluid flow with fluctuations, both when pumping gas and liquid. Fluid sampling membrane pumps or rotary pumps are often used. In the case of a membrane pump, the pump chambers are emptied in cycles by the membrane or membranes creating a pulsating flow. In case of a rotary pump, the flow is driven by rotor blades of a rotor, creating a flow that will have a pulsation resulting from every rotor blade.

The structure of the flow channel in the pump housing and in any connected equipment will also affect and possibly enhance the pulsation present.

There is thus a need for an improved sampling equipment that solves the problems of a pulsating fluid flow through the equipment, the sampling equipment e.g. being sampling equipment for air pollution sampling or water pollution sampling.

### SUMMARY OF THE INVENTION

It is an object of the present invention to improve the current state of the art, to solve the above problems, and to provide an improved method for controlling and/or monitoring of a fluid flow of e.g. a pump so that it may be operated from 1% to 100% of its capacity. These and other objects are achieved by a sampling device for sampling fluid quality comprising a flow channel, through which the fluid is flowing, a pressure sensor provided in said flow channel and adapted to detect a pressure in said flow channel, a membrane provided downstream said pressure sensor in said flow channel and adapted to induce a pressure modification, a control unit connected to said pressure sensor and said membrane, characterized in that said control unit is adapted to activate said membrane so as to induce said pressure modification when said detected pressure deviates from a predetermined pressure interval, thereby neutralizing any pressure fluctuation in said flow channel.

The pressure deviations should be understood as a deviation from the mean flow rate, i.e. the deviation from a laminar flow. The pressure deviations may e.g. be caused by imperfections in the pump inflicting the flow through the sampling equipment. The pressure modification is adapted to correspond to the pressure deviation in such a way that the pressure deviation is the inverse of the pressure fluctuation. By use of the inventive sampling device, the fluctuations in the fluid flow may be cancelled out leaving a laminar fluid flow through the flow channel so that more precise measurements may be done by in the fluid sampling process.

The fluid could be a gas or a liquid that is provided in said flow channel of said sampling device. The fluid could thus be any gas or liquid that is to be tested by said sampling device, e.g. air in working environments, water in environmental situations, or any other gas or liquid where purity is important and pollutants in that specific situation have to be avoided.

The predetermined pressure interval may be based on an average pressure over a predetermined time period detected by said pressure sensor working as a threshold for the cancellation made by the membrane.

According to one aspect of the present invention the pressure sensor of the sampling device is a differential thermal mass flow sensor.

The use of a differential thermal mass flow sensor as pressure sensor is advantageous in the fact that a differential thermal mass flow sensor is a very fast detector. Since the membrane has to be actuated almost immediately a fast detector is important. A differential mass flow sensor measures the fluctuations in mass flow and not the pressure per se. The mass flow measured by the differential mass flow sensor is, however, proportional to the pressure and is sufficient for a feeding via the control unit to the membrane for cancellation of any pulsation.

To give the sampling device control unit time to process the measurements from the pressure sensor, it is advantageous if the pressure sensor is placed upstream of the membrane. A time delay corresponding to the flow velocity is accounted for when sending the signal for actuating the membrane. The membrane should in the sampling device in turn be placed upstream of any sampling equipment for collecting pollutants in the fluid flow, as membranes, adsorptions surfaces, and/or impactor surfaces so that the laminar flow created by the sampling device is used where the laminar flow is important to have.

The differential thermal mass flow sensor preferably at least comprises a heating elements arranged on the inside wall of said flow channel, at least one thermal sensor arranged in the flow direction up-stream said heating element on the inside wall of said flow channel, at least one thermal sensor arranged in the flow direction down-stream said heating element on the inside wall of said flow channel. The temperature in the flow is thus measured upstream by the temperature sensor and then again downstream by another temperature sensor. The mass flow, flowing past the differential mass flow sensor, may thus be estimated by the temperature difference between the upstream temperature sensor and the downstream temperature sensor. If having more than one temperature downstream sensor and/or more than one upstream temperature sensor, the mass flow measurement may be optimized for optimal precision for the current mass flow in the flow channel.

The membrane may preferably be a flexible element adapted to be actuated by said control unit. A typical porous element may e.g. be a speaker membrane electro dynamically driven by a coil placed in a magnetic field, the magnetic field e.g. created by a permanent magnet. The membrane may be of one of the following types,

electro dynamic, comprising a coil attached to said membrane and being adapted to move in a magnetic field;

electrostatic, wherein said membrane is adapted to be provided with an electrical charge and move in an electrostatic field according to the potential of said electrical charge;

magnetostatic, comprising a conductor or a coil integrated in said membrane and being adapted to move in a magnetic field;

piezoelectrical, wherein said membrane comprises a piezoelectric crystalline material that changes its shape when leading an electrical current;

Heil's air motion transducer type wherein said membrane is pleated and mounted in a magnetic field and forced to close and open according to an electrical current.

According to a further aspect of the present invention, the sampling device further comprises a pump adapted to create said flow of fluid in said flow channel.

The invention further relates to a method for sampling fluid quality comprising the steps of: arranging a fluid flow in a flow channel, detecting a pressure in said flow channel with a pressure sensor provided in said flow channel, induce a pressure modification with a membrane provided downstream said pressure sensor in said flow channel, activating said membrane so as to induce said pressure modification when said detected pressure deviates from a predetermined pressure interval, thereby neutralizing any pressure fluctuation in said flow channel.

It should be noted that the inventive method may incorporate any of the features described above in association of the inventive device and has the same corresponding advantages.

Generally, all terms used in the claims are to be interpreted according to their ordinary meaning in the technical field, unless explicitly defined otherwise herein. All references to “a/an/the [element, device, component, means, step, etc.]” are to be interpreted openly as referring to at least one instance of said element, device, component, means, step, etc., unless explicitly stated otherwise.

### BRIEF DESCRIPTION OF THE DRAWINGS

The above objects, as well as additional objects, features and advantages of the present invention, will be more fully appreciated by reference to the following illustrative and non-limiting detailed description of preferred embodiments of the present invention, when taken in conjunction with the accompanying drawings, wherein:

FIG. 1 is a schematic drawing of the sampling device according to the invention.

FIG. 2 is a diagram showing the principle of the cancellation of flow deviations.

### DETAILED DESCRIPTION OF PREFERRED EMBODIMENTS OF THE INVENTION

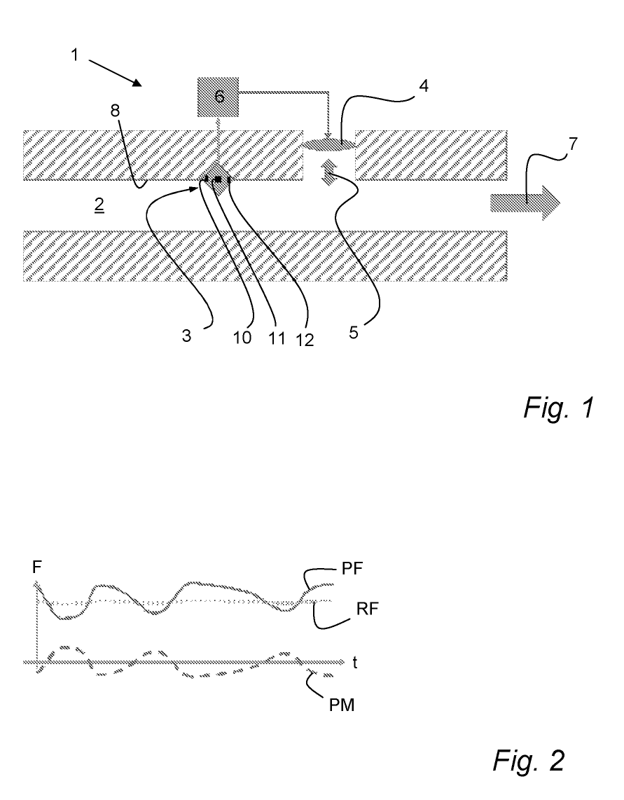

FIG. 1 is a schematic drawing of the sampling device 1 for sampling fluid quality according to the invention. The sampling device comprises a flow channel 2, through which the fluid is flowing 7, PF. A pressure sensor 3 is provided in the flow channel 2 adapted to detect a pressure in the flow channel 2. A membrane 4 is provided downstream the pressure sensor 3 in the flow channel 2 adapted to induce a pressure modification as shown by the arrow 5. The membrane can move so as to induce pressure modification sin the flow channel 2 by moving the fluid in the flow channel 2 with the membrane 4. When the membrane moves away from the flow channel the pressure is decreased in the flow channel 2 and when the membrane is moved towards the flow channel centre the pressure is increased in the flow channel 2. A control unit 6 is connected to the pressure sensor 3 and the membrane 4. The control unit 6 is further adapted to activate the membrane 4 so as to induce the pressure modification when the detected pressure deviates from a predetermined pressure interval, thereby neutralizing any pressure fluctuation in said flow channel, thus providing pulse cancellation. This may be made by having the membrane induce a pressure modification that is the inverse of the measured pressure deviations/fluctuations as shown in FIG. 2.

In FIG. 2 the pulsating flow (PF) is shown in a diagram where the y-axis is the flow rate and the x-axis is time. Pressure modifications (PM) are induced by the membrane 4 creating a pulse-canceling effect resulting in a resulting flow (RF) that is free from fluctuations. The net flow from the pressure modifications (PM) is zero, thus not contributing or affecting the mean flow flowing through the flow channel 2.

The pressure sensor 3 may preferably be a differential thermal mass flow sensor comprising a heating element 11 arranged in on the inside wall 8 of the flow channel 2, at least one up-stream thermal sensor 10 arranged in the flow direction up-stream the heating element 11 on the inside wall 8 of the flow channel, and at least one down-stream thermal sensor 12 arranged in the flow direction 7 down-stream the heating element 11 on the inside wall of the flow channel.

The membrane 4 is a flexible element adapted to be actuated by the control unit 6. The membrane 4 is preferably of a load speaker type, i.e. it is electro-dynamic with a coil (not shown) attached to said membrane 4 wherein the coil is adapted move in a magnetic field created by a magnet (not shown), the magnet being either a permanent magnet or an electro-magnetic magnet. The control unit 6 inverts the pressure signal received from the pressure sensor 3 and sends it to the coil of the membrane membrane so that the membrane will induce the inverted pulsation to that measured by the pressure sensor.

The sampling device preferably further comprises sampling equipment (not shown) for collecting pollutants in the fluid, as membranes, adsorptions surfaces, and/or impactor surfaces. The sampling equipment is preferably placed down-stream the membrane so that the laminar flow created by the sampling device is used where the laminar flow is important to have. A pump (not shown) adapted to create the flow 7, PF of fluid in said flow channel 2. May in turn be placed down-stream the sampling equipment.

It is understood that other variations in the present invention are contemplated and in some instances, some features of the invention can be employed without a corresponding use of other features. Accordingly, it is appropriate that the appended claims be construed broadly in a manner consistent with the scope of the invention.

1. Monitoring apparatus comprising:
a flow channel configured for flow of a fluid therethrough,
a pressure sensor disposed in said flow channel and adapted to detect a pressure in said flow channel,
a membrane configured to induce a pressure modification to said fluid within said flow channel, and
a control unit connected to said pressure sensor and said membrane wherein
said control unit configured to activate said membrane so as to induce said pressure modification when said detected pressure deviates from a predetermined pressure interval, to reduce pressure fluctuations in said flow channel.

2. The monitoring apparatus of claim 1, wherein said predetermined pressure interval is based on an average pressure over a predetermined time period detected by said pressure sensor.

3. The monitoring apparatus of claim 1 wherein said pressure sensor is a differential thermal mass flow sensor.

4. The monitoring apparatus of claim 1 wherein said flow channel includes an inside wall and said flow channel has a flow direction from an upstream location to a downstream location within the flow channel, said differential thermal mass flow sensor comprising:
a heating element disposed on the inside wall of said flow channel,
at least one first thermal sensor positioned in the flow direction up-stream said heating element on the inside wall of said flow channel, and
at least one second thermal sensor positioned in the flow direction downstream of said heating element on the inside wall of said flow channel.

5. The monitoring apparatus of claim 1 wherein said membrane ) is a flexible element adapted to be actuated by said control unit.

6. The monitoring apparatus of claim 1 wherein said membrane comprises one of:
an electro-dynamically actuated membrane, comprising a coil attached to said membrane, wherein said membrane is adapted to move in a magnetic field;
an electrostatically actuated membrane, wherein said membrane is adapted to be provided with an electrical charge and move in an electrostatic field according to a potential of said electrical charge;
a magneto-statically actuated membrane, comprising a conductor or a coil integrated in said membrane and being adapted to move in a magnetic field;
a piezo-electrically actuated membrane wherein said membrane comprises a piezoelectric crystalline material that changes its shape when subjected to an electrical current;
a Heil's air motion actuated membrane wherein said membrane is pleated and mounted in a magnetic field and forced to close and open according to an electrical current; and
a mechanically actuated membrane wherein said membrane is controlled by a mechanical motor, each revolution being synchronized to a measured periodic flow pulsation.

7. The monitoring apparatus of claim 1 further comprising a pump adapted to create said flow of the fluid in said flow channel.

8. A fluid flow monitoring method comprising the steps of:
providing a flow of fluid in a flow channel,
detecting a pressure in said flow channel with a pressure sensor disposed in said flow channel, and
activating a membrane in communication with said fluid to induce a pressure modification in said fluid when said detected pressure deviates from a predetermined pressure interval, to reduce a pressure fluctuation in said flow channel

9. The monitoring apparatus of claim 1 wherein said membrane is disposed in said flow channel upstream of said pressure sensor.

10. The monitoring apparatus of claim 1 wherein said membrane is disposed in said flow channel downstream of said pressure sensor.

11. The monitoring apparatus of claim 1 wherein said membrane is disposed in a channel in fluid communication with said flow channel, wherein said channel in fluid communication with said flow channel is located upstream of said pressure sensor.

12. The monitoring apparatus of claim 1 wherein said membrane is disposed in a channel in fluid communication with said flow channel, wherein said channel in fluid communication with said flow channel is located downstream of said pressure sensor.

13. The fluid flow monitoring method of claim 8 wherein said membrane is disposed in said flow channel upstream of said pressure sensor.

14. The fluid flow monitoring method of claim 8 wherein said membrane is disposed in said flow channel downstream of said pressure sensor.

15. The fluid flow monitoring method of claim 8 wherein said membrane is disposed in a channel in fluid communication with said flow channel and said channel in fluid communication with said flow channel is located upstream of said pressure sensor.

16. The fluid flow monitoring method of claim 8 wherein said membrane is disposed in a channel in fluid communication with said flow channel and said channel in fluid communication with said flow channel is located downstream of said pressure sensor.
